(19) United States
(12) Patent Application Publication
(10) Pub. No.: US 2012/0044561 A1
(43) Pub. Date: Feb. 23, 2012

(54) ELECTROCHROMIC MODULE COMBINED WITH ORGANIC AND INORGANIC MATERIALS AND DISPLAY DEVICE COMBINED WITH THE ELECTROCHROMIC MODULE THEREOF

(75) Inventors: YU-CHOU YEH, TAOYUAN COUNTY (TW); CHAO-YI WANG, TAOYUAN COUNTY (TW); WEN-CHIH LO, TAOYUAN COUNTY (TW); TSUNG-HER YEH, TAIPEI COUNTY (TW)

(73) Assignee: J TOUCH CORPORATION, TAOYUAN COUNTY (TW)

(21) Appl. No.: 13/099,682

(22) Filed: May 3, 2011

(30) Foreign Application Priority Data
Aug. 20, 2010 (TW) 099128034

(51) Int. Cl. G02F 1/153

(52) U.S. Cl. 359/268; 359/265; 359/273

(57) ABSTRACT

In an electrochromic module combined with organic and inorganic materials and a display device combined with the module, the display device has the electrochromic module installed on a surface of an image display module, and the electrochromic module comprises a first transparent substrate, a second transparent substrate, and a transparent conductive element and an electrochromic layer disposed between the substrates, and the electrochromic layer is made of mixing an organic material and an inorganic material into a solvent. With the transfer of electrons between the organic and inorganic materials, the valence of ions of the materials is changed. By gaining electrons for a reduction, and losing electrons for an oxidation, a color change is achieved, and the invention has the advantages of high speed, uniformity, and a low driving voltage.

### CROSS-REFERENCE TO RELATED APPLICATIONS

This non-provisional application claims priority under 35 U.S.C. §119(a) on Patent Application No(s). 099128034 filed in Taiwan, R.O.C. on Aug. 20, 2010, the entire contents of which are hereby incorporated by reference.

### BACKGROUND OF THE INVENTION

1. Field of the Invention

The present invention relates to the field of optoelectronic devices, and more particularly to an electrochromic module combined with organic and inorganic materials and a display device that applies the electrochromic module.

2. Description of the Related Art

Electrochromism (EC) refers to a reversible change of colors of an electrochromic material caused by a light absorption or scattering under the action of a current or an electric field. With reference to FIG. 1 for a conventional electrochromic module 3, the electrochromic module 3 comprises a first transparent conductive element 311 and a second transparent conductive element 321 disposed between a first transparent substrate 31 and a second transparent substrate 32 respectively, and an electrolyte layer 34 and an electrochromic layer 33 disposed between the first transparent substrate 31 and the second transparent substrate 32. In FIG. 2, another electrochromic layer 33 is added, and the electrochromic layer 33 is disposed between the electrolyte layer 34 and the second transparent conductive element 32 and acts as an ion storage layer and an auxiliary color changing layer, and the electrochromic material can be divided into an inorganic electrochromic material and an organic electrochromic material with the following properties in practical applications: (1) good electrochemical redox reversibility, (2) quick color change response time, (3) reversible color change, (4) high sensitivity of color change, (5) long cycle life, (6) certain memory storage function, and (7) good chemical stability.

The conventional electrochromic module 3 is made of a material that uses oxides or hydroxides of transition elements or their derivatives to produce inorganic solid-state films, or mix their organic compounds/electrolyte materials to produce composite materials. With the supply of additional electrons or ion source (an electrolyte or a second electrochromic material), ions are allowed to enter into the crystal lattice to achieve an color change effect of the electrochromic materials such as WO₃, Ni(OH)₂, and Prussian blue Besides the aforementioned electrochromic materials, inorganic electrochromic materials have a stable characteristic, and whose light absorption change is caused by dual addition and dual removal of ions and electrons. The organic electrochromic materials include polyaniline, viologen and rare-earth phthalocyanine and come with a variety of colors. In other words, the organic material is produce by oxidation and reduction. Although the inorganic material provides a faster reaction, it has the issues of environmental protection and toxicity.

Some patents related to the aforementioned electrochromic mechanism and structures are R.O.C. (TW) Pat. No. 1273131 entitled “Electrochromic film” and R.O.C. (TW) Pat. No. 1289236 entitled “Electrochromic display device”, etc.

The principle of a general 3D image display technology adopts a binocular disparity for receiving different images from both left and right eyes of a user respectively, and finally the user's brain merges the images into a 3D image. In naked-eye stereo display technologies, there are two main types of structures, respectively: lenticular lens and barrier. The electrochromic material is used to achieve a barrier, and some patents related to the 3D image display module capable of switching to a display of 3D images or 2D images are given below:

As disclosed in R.O.C. (TW) Pat. No. M368088 entitled “Integrated electrochromic 2D/3D display device, RO.C. (TW) Pat. No. M371902 entitled “Display device for switching 2D image/3D image display screen”, R.O.C. (TW) Pat. No. 1296723 entitled “Color filter used for 3D image LCD panel manufacturing method thereof”, and U.S. Pat. Application No. 2006087499 entitled “Autostereoscopic 3D display device and fabrication method thereof”, electrochromic materials are used as a parallax barrier device for displaying 3D images, but both patents of M368088 and M371902 have a common drawback of lacking a necessary electrolyte layer required by electrochromic devices, since ions are not supplied to the electrolyte layer of the electrochromic layer, thus the electrochromic device cannot produce the reversible oxidation or reduction to complete the change of coloration or decoloration, so that the aforementioned patents are not feasible in practical applications. In addition, the transparent electrode layer and electrochromic material layer of the parallax barrier device are grid patterned, and whose manufacturing process requires a precise alignment for coating, spluttering or etching each laminated layer, and thus the manufacturing process is very complicated, and all laminated layers are grid patterned, so that a hollow area is formed between one grid and the other, and the overall penetration, refraction and reflection of the light will be affected. Even for the general 2D display, the video display quality of the display device will be affected to cause problems related to color difference and uneven brightness. The patent 1296723 disclosed an embedded liquid display device (LCD) formed in a structure of a color filter plate, and the conventional electrochromic materials and chromic mechanisms are used for are the electrochromic layer of the aforementioned patents, and thus requiring a greater driving voltage, causing a defect of the material easily, and resulting in a shorter using life.

### SUMMARY OF THE INVENTION

In view of the foregoing needs, the inventor of the present invention based on years of experience in the related industry to conduct extensive researches and experiments, and finally designed and developed a novel electrochromic module combined with organic and inorganic materials and a display device combined with the module in accordance with the present invention.

Another objective of the present invention is to provide an electrochromic module capable of reducing the thickness and simplifying the manufacturing process.

Another objective of the present invention is to provide an electrochromic module that does not require any additional electrolyte.

Another objective of the present invention is to provide an electrochromic module with a quick coloration/decoloration, a long life cycle, and a low driving voltage.

Another objective of the present invention is to provide an electrochromic module with the advantages of the organic/inorganic electrochromic materials and without any disadvantages of the organic/inorganic electrochromic materials.

To achieve the forgoing objective, the electrochromic module of the present invention is manufactured by an electrochromic material made by dissolving an organic material and an inorganic material into a solvent, and the organic material includes a redox indicator, and an acid-base indicator, and the inorganic material includes a transition element (such as an oxide, a sulfide, a chloride, a hydroxide, or an inorganic derivative of a scandium subgroup (IIIB), a titanium subgroup (IVB), a vanadium subgroup (VB), a chromium subgroup (VIB), a manganese subgroup (VIIB), an iron series (VIII), a copper subgroup (IB), a zinc subgroup (IIB) or a platinum series (VIII)), one of the inorganic derivative of a halogen group (VIIA), an oxygen group (VIA), a nitrogen group (VA), a carbon group (IVA), a boron group (IIIA), an alkali earth metal group (IIA), and an alkali metal group (IA), with a color changing mechanism using organic and inorganic materials to form a complementary system. In this system, an electrically conductive element supplies electrons, such that reduction can occur in the organic material of the electrochromic material, such that after the reduction takes place, the electric potential of its free radical or ionic state is different from the electric potential of ions of the inorganic material. Therefore, the electrons are transferred from organic ions to inorganic ions to change the valence of the material to change the color. The concept of gaining electrons for a reduction and losing electrons for an oxidation achieves a coloration/decoloration with the advantages of high speed, uniformity, low driving voltage and long lifespan.

To achieve the forgoing objective, the present invention provides an electrochromic module combined with organic and inorganic materials, and the electrochromic module comprises a first transparent substrate, a second transparent substrate, an electrochromic layer disposed between the transparent substrates, and at least one transparent conductive element, wherein the transparent conductive element is disposed on a surface of the first transparent substrate, or disposed on a surface of the second transparent substrate, or disposed on both surfaces of the corresponding first and second transparent substrates, and the ion valance of the electrochromic layer can be changed by the electrons supplied by the transparent conductive element and the complementary mechanism of the electrochromic material to produce a color change. Another objective of the present invention is to provide a display device that uses the electrochromic module, and has the effect of switching its display status to 2D images and 3D images.

Another objective of the present invention is to provide a display device capable of increasing the contact area between the electrochromic module and electrodes to improve the color changing speed.

To achieve the forgoing objectives, the present invention combines the electrochromic module with an image display module to produce the display device, and when the display device switches its display status from a 2D image to a 3D image, the displayed image is divided into a left-eye image and a right-eye image. Now, the transparent conductive element is electrically conducted, such that the color of the electrochromic layers is changed from a transparent area into a dark light shield area according to the arrangement of the electrochromic units with an interval apart from each other. The electrochromic unit produces a plurality of light shield areas arranged with an interval apart and divides the 3D image into a left-eye image and a right-eye image by eliminating the portion of an overlapped image area in the light shield area, such that after our naked eyes receive the images, overlapped patterns will not be produced, and the 3D image will be formed.

To achieve the forgoing objective, the present invention applies the electrochromic module as a mask of the 3D image display device, wherein the electrochromic layers are arranged with an interval apart from each other in the module, and the electrochromic modules can be installed by three methods. In the first method, the electrochromic layers mixed with conductive polymers are disposed by a screen printing method. In the second method, an isolating unit is used for separating the electrochromic layers arranged with an interval apart into a plurality of strips. In the third method, the transparent conductive elements are used as isolating units directly. All of the foregoing methods use the electrochromic layers to produce a light shield area of grids to form the barrier.

In general, either a lenticular or a barrier is installed additionally to the display device for displaying 3D image, but the display device having the electrochromic module combined with organic and inorganic materials in accordance with the present invention display the 3D image which has been divided into the left-eye image and the right-eye image.

### BRIEF DESCRIPTION OF THE DRAWINGS

FIG. 1 is a first cross-sectional view of a conventional electrochromic module;

FIG. 2 is a second cross-sectional view of a conventional electrochromic module;

FIG. 3 is an exploded view of a first preferred embodiment of the present invention;

FIG. 4 is a first schematic view of a transparent conductive element in accordance with a first preferred embodiment of the present invention;

FIG. 5 is a second schematic view of a transparent conductive element in accordance with a first preferred embodiment of the present invention;

FIG. 6 is a third schematic view of a transparent conductive element in accordance with a first preferred embodiment of the present invention;

FIG. 7 is an exploded view of a second preferred embodiment of the present invention;

FIG. 8 is a first schematic view of a transparent conductive element in accordance with a second preferred embodiment of the present invention;

FIG. 9 is a second schematic view of a transparent conductive element in accordance with a second preferred embodiment of the present invention;

FIG. 10 is a first schematic view of a transparent conductive element in accordance with a third preferred embodiment of the present invention;

FIG. 11 is a second schematic view of a transparent conductive element in accordance with a third preferred embodiment of the present invention;

FIG. 12 is an exploded view of a fourth preferred embodiment of the present invention;

FIG. 13 is a cross-sectional view of a fourth preferred embodiment of the present invention;

FIG. 14 is a cross-sectional view of a fifth preferred embodiment of the present invention;

FIG. 15 is a schematic view of a transparent conductive element in accordance with a fifth preferred embodiment of the present invention;

FIG. 16 is a cross-sectional view of a sixth preferred embodiment of the present invention;

FIG. 17 is a first top view of a transparent conductive element in accordance with a sixth preferred embodiment of the present invention;

FIG. 18 is a first perspective view of a transparent conductive element in accordance with a sixth preferred embodiment of the present invention;

FIG. 19 is a second perspective view of a transparent conductive element in accordance with a sixth preferred embodiment of the present invention;

FIG. 20 is a second top view of a transparent conductive element in accordance with a sixth preferred embodiment of the present invention;

FIG. 21 is a cross-sectional view of a seventh preferred embodiment of the present invention:

FIG. 22 is a top view of a transparent conductive element in accordance with a seventh preferred embodiment of the present invention;

FIG. 23 is a perspective view of a transparent conductive element in accordance with a seventh preferred embodiment of the present invention;

FIG. 24 is a cross-sectional view of an eighth preferred embodiment of the present invention;

FIG. 25 is a cross-sectional view of a ninth preferred embodiment of the present invention;

FIG. 26 is a cross-sectional view of a tenth preferred embodiment of the present invention;

FIG. 27 is a cross-sectional view of an eleventh preferred embodiment of the present invention;

FIG. 28 is a cross-sectional view of a twelfth preferred embodiment of the present invention; and

FIG. 29 is a cross-sectional view of a thirteenth preferred embodiment of the present invention.

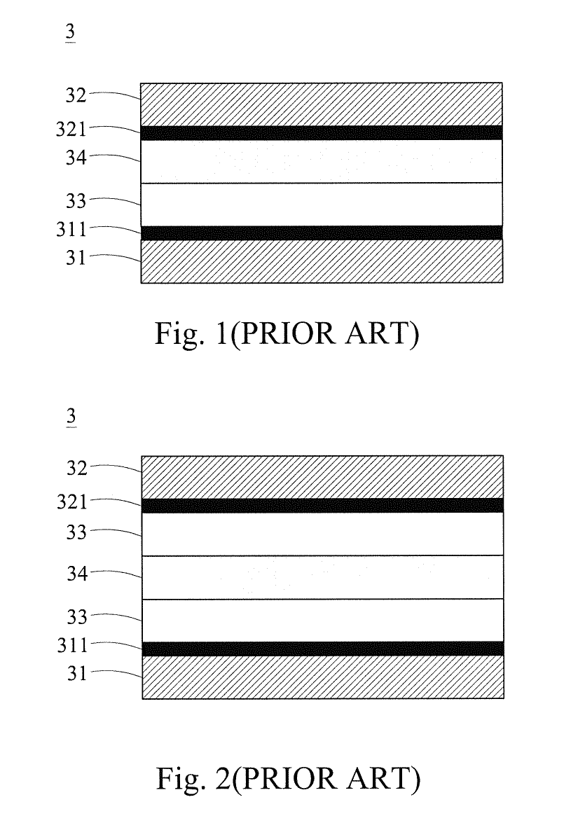

### DETAILED DESCRIPTION OF THE PREFERRED EMBODIMENTS

The technical characteristics and effects of the present invention will be apparent with the detailed description of preferred embodiment together with the illustration of related drawings as follows.

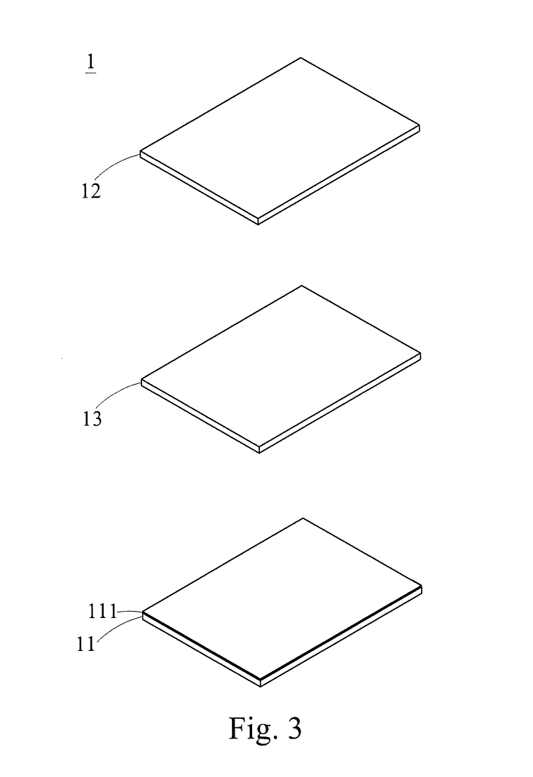

With reference to FIG. 3 for an exploded view of a first preferred embodiment the present invention, the electrochromic module 1 of the present invention comprises: a first transparent substrate 11, a second transparent substrate 12 and an electrochromic layer 13.

The first transparent substrate 11 includes a first transparent conductive element 111 disposed on a surface of the first transparent substrate 11, and the first transparent substrate 11 and the second transparent substrate 12 are made of a material selected from the collection of plastic, polymer plastic and glass or a plastic polymer selected from the collection of resin, polyethylene terephthalate (PET), polycarbonate (PC), polyethylene (PE), polyvinyl chloride (PVC), polypropylene (PP), polystyrene (PS) and polymethylmethacrylate (PMMA) or their mixture. The first transparent conductive element 111 is made of an impurity-doped oxide selected from the collection of indium tin oxide (ITO), indium zinc oxide (IZO), Al-doped ZnO (AZO) and antimony tin oxide (ATO), or a highly electrically conductive polymer material selected from the collection of carbon nanotube or poly-3,4-ethylenedioxythiophene (PEDOT).

The electrochromic layer 13 is disposed between the first transparent substrate 11 and the second transparent substrate 12 and covered onto a surface of the first transparent conductive element 111, and the electrochromic layer 13 is made of a material produced by mixing an organic material and an inorganic material into a solvent, and the electrochromic layer 13 has the oxidation and reduction characteristics by the complementary effect of the organic material and the inorganic material. In the color changing principle, electrons are supplied to an electrically conductive element, such that electrons are transferred and transported in the electrochromic material to change the ion valence for the change of color, and the valence can be restored by gaining electrons, and an oxidation can be achieved by losing electrons. Compared with the conventional coloration/decoloration, the color changing mechanism can be achieved by the intercalation and de-intercalation of electrons and ions, and coloration/decoloration of the present invention has the advantages of high speed, uniformity, low driving voltage and a long lifespan.

The organic material includes a redox indicator and an acid-base indicator, etc.

Wherein, the redox indicator is an indicator used for a redox titration and capable of producing a significant color change at a specific electrode potential. In general, the organic testing agent with a redox property has a different color at an oxidation state or a reduction state, and there are two common types of redox indicators, respectively: a metal organic coordination compound and an organic redox system. Almost all redox indicators and redox systems are related to protons (H⁺) and used as a participant of an electrochemical reaction, such that the redox indicator can be divided by the aforementioned characteristic into two types: a pH dependent redox indicator and a pH independent redox indicator. The pH independent redox indicator includes: 2,2′-bipyridine coordination ion, 5-ferroin coordination ion, N-phenyl-o-anthranilic acid, 1,10-phenanthroline-ferrous coordination ion, erioglaucine disodium salt, paraquat, 2,2′-dipyridyl-ferrous coordination ion, 5,6-dimethyl ferroin coordination ion, 3,3′-dimethoxybenzidine, sodium diphenylamine sulfonate, N,N′-diphenylbenzidine, N-phenylaniline, methyl viologen, but some of the aforementioned indicators are toxic; and the pH dependent redox indicator includes: dichlorophenolindophenol sodium, methylndophenol sodium, thionine, methylene blue, indigo tetrasulfonic acid, indigo trisulfonic acid, indigo carmine, indigo monosulfonic acid, phenyl red, safranin T, and neutral red.

The acid-base indicator is used for testing a pH value of a chemical testing agent, and the acid-base indicator is a weak acid or a weak alkali containing a pigment, and the pigment will be combined with hydrogen ions or hydroxide ions to become a corresponding acidic or alkaline form to show a different color when the acid-base indicator is dropped into a solution. Since the acid-base indicator produces a reversible color change when the acid-base indicator is dropped into a solution with a different pH value, therefore it can indicate the end of a reaction in a neutralization analysis and measure the pH value of the testing solution. The common acid-base indicator used in a laboratory includes: phenolsulfonphthalein, Congo red, methyl orange, phenol, thymol blue, litmus, methyl purple, malachite green, methyl yellow, bromophenol blue, bromocresol green, methyl red, bromocresol purple, bromothymol blue, thymolphthalein, mordant orange R.

The redox indicator of the ion layer of the present invention is preferably methylene blue (C₁₆H₁₈ClN₃S.3H₂O), dichlorophenolindophenol sodium (C₁₂H₆Cl₂NNaO₂), N-phenyl-o-anthranilic acid (C₁₃H₁₁NO₂), sodium diphenylamine sulfonate (C₁₂H₁₀NNaO₃S), N,N′-diphenylbenzidine (C₂₀H₂₀N₂) or methyl viologen, and the acid-base indicator is preferably a variamine blue B diazonium salt (C₁₃H₁₂ClN₃O).

The solvent is dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxylpropionitrile, dimethyl-formamide, N-methylpyrrolidone, sulfon, 3-methyl sulfone or their mixtures.

The inorganic material is an oxide, sulfide, chloride, hydroxide or an inorganic derivate of a transition element, or an inorganic derivative selected from the collection of a halogen group (VIIA), an oxygen group (VIA), a nitrogen group (VA), a carbon group (IVA), a boron group (IIIA), an alkali earth metal group (HA), and an alkali metal group (IA).

The transition metal element is an element selected from the collection of a copper subgroup (IB), a zinc subgroup (IIB), a scandium subgroup (IIIB), a titanium subgroup (IVB), a vanadium subgroup (VB), a chromium subgroup (VIB), a manganese subgroup (VIIB), an iron series (VIIIB) and a platinum series (Group VIIIB of Fifth and Sixth Periods).

Examples of various different groups mentioned above are listed and described below:

Halogen Group (VIIA):

Solid: I₂ purplish black; ICl dark red; IBr dark grey; IF₃ yellow; ICl₃ orange; I₂O₅ white; I₂O₄ yellow(ion crystal); I₄O₉ yellow (ion crystals).

Oxygen Group (VIA):

Solid: S light yellow; Se grey, brown; Te colorless metal luster; Na₂S,(NH₄)₂S, K₂S,BaS white, soluble; ZnS white↓; MnS red fleshy; FeS black↓; PbS black↓; CdS yellow↓; Sb₂S₃ orange red↓; SnS brown↓; HgS black (precipitate), red (cinnabar red); Ag₂S black↓; CuS black↓; Na₂S₂O₃ white; Na₂S₂O₄ white; SeO₂ white, volatile; SeBr₂ red; SeBr₄ yellow; TeO₂ white heated to become yellow; H₂TeO₃ white; TeBr₂ brown; TeBr₄ orange; TeI₄ grayish black; PoO₂ low-temperature yellow (face-centered cube),high-temperature red (tetrahedron); SO₃ colorless; SeO₃ colorless easily soluble in water; TeO₃ orange; H₆TeO₆ colorless.

Nitrogen Group (VA):

Solid: ammonium salt colorless crystal; nitrified metal white; N₂O₃ blue (low-temperature); N₂O₅ white; P white, red, black; P₂O₃ white; P₂O₅ white; PBr₃ yellow; PI₃ red; PCl₅ colorless; P₄Sx yellow; P₂S₃ grayish yellow; P₂S₅ light yellow; H₄P₂O₇ colorless glass form; H₃PO₂ white; As grey; As₂O₃ white; As₂O₅ white; AsI₃ red; As₄S₄ red (arsenic disulfide); As₄S₆ yellow(arsenic trisulphide); As₂S₅ light yellow; Sb silver white; Sb(OH)₃ white↓; Sb₂O₃ white (antimony white pigment); Sb₂O₅ light yellow; SbX₃(X< >I) white; SbI₃ red; Sb₂S₃ orange red↓; Sb₂S₅ orange yellow; Bi silver white and slightly red; BI₂O₃ light yellow; Bi₂O₅ reddish brown; BiF₃ grayish white; BiCl₃ white; BiBr₃ yellow; BiI₃ black↓; Bi₂S₃ brownish black.

Carbon Group (IVA):

Solid: C(corundum) colorless transparent; C (graphite) black color metal luster; Si grayish black color metal luster; Ge grayish white; Sn silver white; Pb dark grey; SiO₂ colorless transparent; H₂SiO₃ colorless transparent gel ↓; Na₂SiF₆ white crystal; GeO black; GeO₂ white; SnO black; SnO₂ white; Sn(OH)₂ white↓; PbO yellow or yellowish red; Pb₂O₃ orange; Pb₃O₄ red; PbO₂ brown; CBr₄ light yellow; Cl₄ light red; GeI₂ orange; GeBr₂ yellow; GeF₄ white; GeBr₄ grayish white; GeI₄ yellow; SnF₂ white; SnCl₂ white; SnBr₂ light yellow; SnI₂ orange; SnF₄ white; SnBr₄ colorless; SnI₄ red; PbF₂ colorless ↓; PbCl₂ white↓; PbBr₂ white; PbI₂ gold yellow; PbF₄ colorless; GeS red; GeS₂ white; SnS brown ↓; SnS₂ gold yellow (commonly called gold powder)↓; PbS black↓; PbS₂ reddish brown; Pb(NO₃)₂ colorless; Pb(Ac)₂.3H₂O colorless crystal; PbSO₄ white↓; PbCO₃ white↓; Pb(OH)₂ white↓; Pb₃(CO₃)₂(OH)₂ lead white↓; PbCrO₄ white yellow↓.

Boron Group (IIIA):

Solid: B (with no fixed shape) brown powder; B(crystal) grayish black; Al silver white; Ga silver white (easily liquefied); In silver grey; Tl silver grey; B₂O₃ glass form; H₃BO₃ colorless sheet form; BN white; Na₂B₄O₇.10H₂O white crystal; Cu(BO₂)₂ blue↓; Ni(BO₂)₂ green ↓; NaBO₂.Co(BO₂)₂ blue ↓; NaBO₂.4H₂O colorless crystal; non-aqueous NaBO₂ yellow crystal; Al₂O₃ white crystal; AlF₃ colorless; AlCl₃ white; AlBr₃ white; AlI₃ brown; Al(OH)₃ white↓; Ga₂O₃ white↓ Ga(OH)₃ white↓; GaBr₃ white; GaI₃ yellow; In₂O₃ yellow; InBr₃ white; InI₃ yellow; TIOH yellow; TI₂O black; TI₂O₃ brownish black; TICl white↓; TlBr light yellow↓; TlI yellow↓ (similar to silver); TlBr₃ yellow; TlI₃ black.

Alkali Earth Metal (IIA):

Elementary substance: silver white

Flame color: Ca brick red; Sr magneta; Ba green.

Oxides: All oxides are white solids.

Hydroxides: White solids Be(OH)₂↓, Mg(OH)₂↓.

Salts: Most salts are colorless or white crystals; BeCl₂ light yellow; BaCrO₄ yellow↓; CaF₂ white↓.

Alkali Metal (IA):

Elementary substance: silver white

Flame color: Li red; Na yellow; K purple; Rb purplish red; Cs purplish red.

Oxide, Peroxide, Super Oxide, Ozonide: Li₂O white; Na₂O white; K₂O light yellow; Rb₂O white yellow; Cs₂O orange red; Na₂O₂ light yellow; KO₂ orange yellow; RbO₂ dark brown; CsO₂ dark yellow; KO orange red.

Hydroxide: white, LiOH white↓.

Salt: Most salts are colorless or white crystals and easily soluble in water.

Insoluble salt↓, (all are white crystals unless otherwise stated): LiF Li₂CO₃ Li₃PO₄ LiKFeIO₆ Na[Sb(OH)₆]NaZn(UO₂)₃(Ac)₉6.H₂O yellow green; M=K,Rb,Cs M₃[Co(NO₂)₆]white yellow; MBPh₄ MClO₄ M₂PtCl₆ light yellow; CsAuCl₄.

Copper Subgroup (IB):

Elementary substance: Cu purplish red or dark red; Ag silver white; Au gold yellow.

Copper compound: Flame color green; CuF red; CuCl white↓; CuBr yellow↓; CuI brownish yellow↓; CuCN white↓; Cu₂O dark red; Cu₂S black; CuF₂ white; CuCl₂ brownish yellow (yellowish green solution); CuBr₂ brown; Cu(CN)₂ brownish yellow; CuO black↓; CuS black↓; CuSO₄ colorless; CuSO₄5.H₂O blue; Cu(OH)₂ light blue↓; Cu(OH)₂.CuCO₃ green black;[Cu(H₂O)₄]²⁺ blue; [Cu(OH)₄]²⁻ bluish purple; [Cu(NH3)₄]²⁺ dark blue; [CuCl₄]²⁻ yellow;[Cu(en)₂]²⁺ dark bluish purple; Cu₂[Fe(CN)₆]brown red; cuprous acetylide red ↓.

Silver compound: AgOH white (decomposed at normal temperature); Ag₂O black; freshly made AgOH brownish yellow (mixed with Ag₂O); silver proteinate (AgNO₃ dropped on hands) black↓; AgF white; AgCl white↓; Ag bright yellow↓; AgI yellow↓ (gel); Ag₂Sblack↓; Ag₄[Fe(CN)₆]white↓; Ag₃[Fe(CN)₆]white↓; A_{g}⁺, [Ag(NH₃)₂]⁺, [Ag(S₂O₃)₂]³⁻,[A_{g}(CN)₂]⁻ colorless.

Gold compound: HAuCl₄.3H₂O white yellow crystal; KAuCl₄.1.5H₂O colorless sheet crystal; Au₂O₃ black; H[Au(NO₃)₄].3H₂O yellow crystal; AuBr grayish yellow↓; AuI lemon yellow↓.

Zinc Subgroup (IIB):

Elementary substance: All elementary substances are silver white, and the Hg precipitate in water solution is black.

Zinc compound: ZnO white (zinc white pigment) ↓; ZnI₂ colorless; ZnS white ↓; ZnCl₂ white crystal (highly soluble, water-soluble, acidic); K₃Zn₃[Fe(CN)₆] white; Zn₃[Fe(CN)₆]₂ yellowish brown.

Cadmium compound: CdO brownish grey↓; CdI₂ yellow; CdS yellow (cadmium yellow pigment) ↓; HgCl₂ (mercury perchloride) white; HgNH₂Cl white↓; Hg₂Cl₂(mercurous chloride) white↓.

Mercury compound: HgO red (large crystal grain) or yellow (small crystal grain) ↓; HgI₂ red or yellow (slightly soluble); HgS black or red↓; Hg₂NI.H₂O red↓; Hg₂(NO₃)₂ colorless crystal.

ZnS phosphor: Ag blue; Cu yellowish green; Mn orange.

Titanium Subgroup (IVB):

Titanium compound: Ti³⁺ purplish red; [TiO(H₂O₂)₂]²⁺ orange yellow; H₂TiO₃ white ↓; TiO₂ white (titanium white pigment) or Mona red (ruffle)↓; (NH₄)₂TiCl₆ yellow crystal; [Ti(H₂O)₆]Cl₃ purple crystal; [Ti(H₂O)₅Cl]Cl₂.H₂O green crystal; TiCl₄ colorless smoke-generating liquid.

Zirconium, hafnium: MO₂, MCl₄ white.

Vanadium Subgroup (VB):

Vanadium compound: V²⁺ purple; V³⁺ green; VO²⁺ blue; V(OH)⁴⁻ yellow; VO4³⁻ yellow; VO black; V₂O₃ grayish black; V₂S₃ brownish black; VO₂ blue solid; VF₄ green solid; VCl₄ dark brown liquid; VBr₄ magneta liquid; V₂O₅ yellow or brick red; hydrate V₂O₅ brownish red; saturated V₂O₅ solution (slightly soluble) light yellow; [VO₂(O₂)₂]³⁻ yellow; [V(O₂)₃]³⁻ reddish brown.

Vanadium acid radical polycondensation: As the atomic number of vanadium reduces, the color changes from a light yellow to dark red˜light yellow.

Columbium, tantalum: omitted.

Chromium Subgroup (VIB):

Chromium compound: Cr²⁺ blue; Cr³⁺ purple; Cr₂O₇²⁻ orange red; CrO₄²⁻ yellow; Cr(OH)⁴⁻ bright green; Cr(OH)₃ grayish blue; Cr₂O₃ green; CrO₃ dark red needle shape; [Cro(O₂)₂]OEt₂ blue; CrO₂Cl₂ dark red liquid; Na₂Cr₂O₇, K₂CrO₇ orange red; Ag₂CrO₄ brick red ↓; BaCrO₄ yellow↓; PbCrO₄ yellow↓.

Purplish red Cr₂(SO₄)₃.18H₂O->Green Cr₂(SO₄)₃.6H₂O->Peach red Cr₂(SO₄)₃

Dark green [Cr(H₂O)₄Cl₂]Cl-cooling HCl->purple [Cr(H₂O)₆]Cl₃-ethylether HCl->light green [Cr(H₂O)₅Cl]Cl₂

[Cr(H₂O)₆]³⁺ purple; [Cr(H2O)₄(NH3)₂]³⁺ purplish red; [Cr(H2O)₃(NH₃)₃]³⁺ light red; [Cr(H₂O)₂(NH₃)₄]³⁺ orange red; [Cr (NH₃)₅H₂O]³⁺ orange yellow; [Cr(NH₃)₆]³⁺ yellow.

Molybdenum, tungsten: MoO₃ white; brownMoCl₃; green MoCl₅; MoS₃ brown↓; (NH₄)₃[P(Mo₁₂O₄₀].6H₂O yellow crystal form↓; WO₃ dark yellow; H₂WO₄.xH₂O white gel.

Manganese Subgroup (VIIB):

Manganese compound: Mn²⁺ flesh red; Mn³⁺ purplish red; MnO₄²⁻ green; MnO₄⁻ purple; MnO³⁺ bright green; Mn(OH)₂ white↓; MnO(OH)₂ brown↓; MnO₂ black↓; non-aqueous manganese salt (MnSO₄) white crystal; hexahydrate manganese salt (MnX₂.6H₂O, X=halogen, NO₃, ClO₄) pink; MnS.nH₂O flesh red↓; non-aqueous MnS dark green; MnCO₃ white↓; Mn₃(PO₄)₂ white↓; KMnO₄ purplish red; K₂MnO₄ green; K₂[MnF₆] gold yellow crystal; Mn₂O₇ brown oily liquid.

Technetium, Rhenium: omitted.

Iron Series (Group VIII of fourth period):

Iron compound: Fe²⁺ light green; [Fe(H₂O)₆]³⁺ light purple; [Fe(OH)(H₂O)₅]²⁺ yellow; FeO₄²⁻ purplish red; FeO black; Fe₂O₃ dark red; Fe(OH)₂ white↓; Fe(OH)₃ brownish red↓; FeCl₃ or FeCl₂ crystal brown red blue; non-aqueous FeSO₄ white; FeSO₄.7H₂O green; K₄[Fe(CN)₆](yellow prussiate) yellow crystal; K₃[Fe(CN)₆](red prussiate) red crystal; Fe₂[Fe(CN)₆] Prussian blue ↓; Fe[Fe(CN)₆]black↓; Fe(C₅H₅)₂ (ferrocene) orange yellow crystal; M₂Fe₆(SO₄)₄(OH)₁₂ (yellow ferrous sulfate, M=NH₄, Na, K) light yellow crystal; Fe(CO)₅ yellow liquid.

Cobalt compound: Co²⁺ pink; CoO grayish green; CO₃O₄ black; Co(OH)₃ brown↓; Co(OH)₂ pink↓; Co(CN)₂ red; K₄[Co(CN)₆] purple crystal; CO₂(CO)₈ yellow crystal; [Co(SCN)₆]₄-purple;

Cobalt chloride is dehydrated into pink CoCl₂.6H₂O-325K->purplish red CoCl.2H₂O-313K->bluish purple CoCl₂.H₂O-393K->blue CoCl₂.

Nickel compound: Ni²⁺ bright green; [Ni(NH₃)₆]²⁺ purple; Ni(OH)₂ green ↓; Ni(OH)₃ black↓; non-aqueous Ni(II) salt yellow; Na₂[Ni(CN)₄] yellow; K₂[Ni(CN)₄] orange; Ni(CO)₄ colorless liquid.

Platinum Series Element (Group VIII of Fifth and Sixth Periods):

Os bluish grey volatile solid; PdI(aq) black; OsO₄ colorless special-odor gas;

H₂PtCl₆ orange red crystal; Na₂PtCl₆ orange yellow crystal; M₂PtCl₆ (M=K, Rb, Cs, NH₄) yellow↓.

In the aforementioned compounds, the inorganic material of the present invention is preferably ferrous chloride (FeCl₂), ferric trichloride (FeCl₃), titanium trichloride (TiCl₃) or titanium tetrachloride (TiCl₄).

In the color changing mechanism, ferrous chloride (FeCl₂) and methylene blue are dissolved in dimethyl sulfoxide (DMSO) to produce an electrochromic solution of a complementary system, and ferrous chloride crystal particles are in blue color (since Fe²⁺ is blue), and the oxidized surface is in a reddish brown color (since Fe³⁺ is light yellow), and ferrous chloride is dissolved in a solvent, and Fe²⁺ is oxidized to form Fe³⁺, such that the solvent becomes light yellow. The first transparent conductive element 111 supplies electrons, such that when methylene blue molecules approaching to the first transparent conductive element 111 gain electrons to produce a reduction, the methylene blue becomes a free radical, and when the external voltage is removed, Fe³⁺ is a methylene blue free radical with a different electric potential energy level, and electrons will be transmitted from the methylene blue free radical to Fe³⁺, so that the light yellow Fe³⁺ is reduced to the blue Fe²⁺, and the whole ion layer 24 changes its color from light yellow to blue due to the change of valence, so as to achieve a dark color change effect. The concentration, potential difference, solvent polarity, pH value, electrode gap and dielectric constant of the electrochromic solution can be adjusted for controlling the color displaying effect of the electrochromic layer 13.

The electrochromic layer 13 further includes at least one inert conductive salt, wherein the inert conductive salt can be lithium, sodium, or tetra-alkylamine salt. The conductive salt is applicable for anions, particularly it can provide the redox inertness of the metallic salt, and the colorless anion can be a tetrafluoroborate ion, a tetraphenylborate ion, a cyanophenylborate ion, a tetramethoxyborate ion, a perchlorate ion, a chloride ion, a nitrate ion, sulfate ion, a phosphate ion, a methanesulfate ion, an ethanesulfate ion, a tetradecylsulfate ion, a pentadecanesulfonate ion, a trifluoromethanesulfonate ion, a perfluorobutane sulfonate ion, a perfluorooctane sulfonate ion, a benzene sulfonate ion, a chlorobenzenesulfonate ion, a toluene sulfonate ion, a butylbenzene sulfonate ion, a tert-butylbenzene sulfonate ion, a dodecylbenzene sulfonate ion, a trifluoromethylbenzene sulfonate ion, a hexafluorophosphate ion, a hexafluoroarsenate ion, or a hexafluorosilicate ion.

Further, most of the electrochromic layers 13 are in a liquid form, but they also can be mixed with highly conductive polymers to form an electrochromic ink to be used together with a screen printing method.

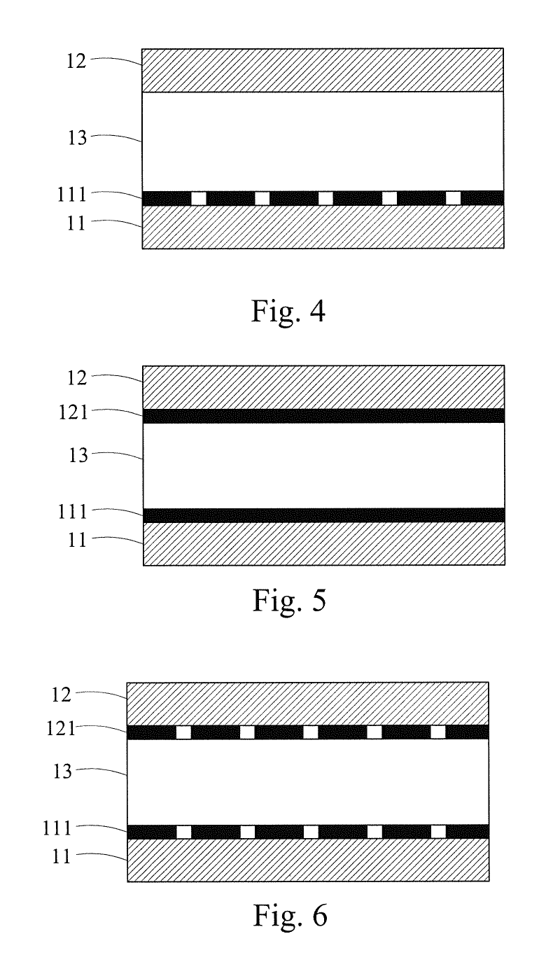

With reference to FIGS. 4 to 6 for the first to third schematic views of a transparent conductive element in accordance with a first preferred embodiment of the present invention respectively, the transparent conductive element of this preferred embodiment is the first transparent conductive element in the electrochromic module 1. If there is a plurality of first transparent conductive elements disposed on a first substrate (as shown in FIG. 4), the first transparent conductive elements are preferably arranged with an interval apart from each other for supplying voltages of different potentials alternately, such that a voltage difference is produced between the electrodes to provide the electrons required for the color change of an electrochromic layer 13. In addition, a first transparent conductive element 111 and a second transparent conductive element 121 can be formed on the first transparent substrate 11 and the second substrate 12 respectively, and the electrochromic layer 13 is included between the first transparent conductive element 111 and the second transparent conductive element 121 (as shown in FIG. 5), or the transparent conductive elements 111, 121 are arranged with an interval apart from each other and disposed on the first transparent substrate 11 and second transparent substrate 12 (as shown in FIG. 6).

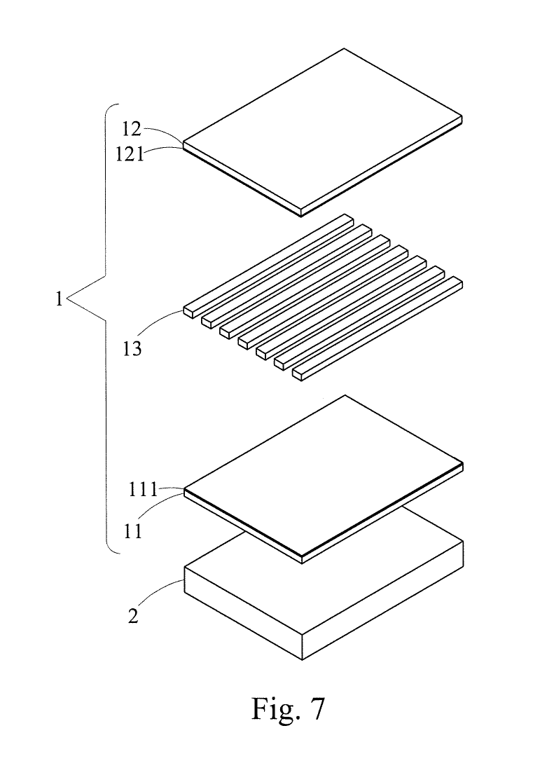

The aforementioned electrochromic module 1 can be applied to display devices, eBooks, 2D/3D display devices, rearview mirrors and intelligent glass. With reference to FIG. 7 for an exploded view of a second preferred embodiment of the present invention, the aforementioned electrochromic module is applied to a 2D/3D display device, and the display device of the present invention includes an electrochromic module 1 combined with an image display module 2, wherein the image display module 2 is provided for displaying a 2D image and a 3D image, and the displayed 3D image can be generated by a software, firmware or hardware technology. For example, software or firmware is used to convert a 2D image into an overlapped image including a left-eye image and a right-eye image. The image display module 2 can be a liquid crystal display (LCD), a plasma display panel (PDP), a surface conduction electron-emitter display (SED), a field emission display (FED), a vacuum fluorescent display (VFD), an organic light-emitting diode (OLED) or an E-paper.

The electrochromic module 1 is combined onto a surface of the image display module 2 and includes a first transparent substrate 11, a second transparent substrate 12 and a plurality of electrochromic layers 13.

The first transparent substrate 11 has a first transparent conductive element 111 disposed on an upper surface of the first transparent substrate 11, and the second transparent substrate 12 has a second transparent conductive element 121 disposed on a lower surface of the second transparent conductive layer 121, and the electrochromic layers 13 produce a color change by an electric conduction of the first transparent conductive element 111 and the second transparent conductive element 121. However, the drawings are provided for illustrating the invention. The invention is not limited to arranging a plurality of transparent conductive elements on a single substrate (as shown in FIG. 12) only, but any other equivalent arrangement can be used as long as each electrochromic layer 13 can be contacted with the transparent conductive elements of different potentials at the same time to transfer and supply electrons to the electrochromic layers for the change of color.

The first transparent substrate 11 and the second transparent substrate 12 are made of the same material of the first transparent conductive element 111, and thus they will not be described here again.

The electrochromic layers 13 is made of a material produced by dissolving an organic material and an inorganic material into a solvent, and the organic material can be a redox indicator and an acid-base indicator, preferably methylene blue (C₁₆H₁₈ClN₃S.3H₂O), dichlorophenolindophenol sodium (C₁₂H₆Cl₂NNaO₂), N-phenyl-o-anthranilic acid (C₁₃H₁₁NO₂), sodium diphenylamine sulfonate (C₁₂H₁₀NNaO₃S), N,N′-diphenylbenzidine (C₂₀H₂₀N₂) or methyl viologen and variamine blue B diazonium salt (C₁₃H₁₂ClN₃O), and the inorganic material is an oxide, a sulfide, a chloride, a hydroxide, or an inorganic derivative of a transition element (selected from the collection of a scandium subgroup (IIIB), a titanium subgroup (IVB), a vanadium subgroup (VB), a chromium subgroup (VIB), a manganese subgroup (VIIB), an iron series (VIII), a copper subgroup (IB), a zinc subgroup (IIB) and a platinum series (VIII)), or an inorganic derivative selected from the collection of a halogen group (VIIA), an oxygen group (VIA), a nitrogen group (VA), a carbon group (IVA), a boron group (IIIA), an alkali earth metal group (IIA), and an alkali metal group (IA), wherein the preferred embodiment of the present invention adopts ferrous chloride (FeCl₂), ferric trichloride FeCl₃), titanium trichloride (TiCl₃), titanium tetrachloride (TiCl₄), bismuth chloride (BiCl₃), copper chloride (CuCl₂) or lithium bromide (LiBr); and the solvent is one selected from the collection of dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxyl propionitrile, dimethyl-formamide, N-methylpyrrolidone, sulfon, 3-methyl sulfone and their mixtures. Compared with a general inorganic electrochromic layer, the inorganic electrochromic layer of the present invention requires loading ions and electrons into crystal lattices, and thus requiring a higher driving voltage, so that the solution may cause defects to the materials, and the lifespan is just ten to twenty thousand times only. In the concept of the present invention, it is necessary to change the valence of ions in the electrochromic material without requiring a high driving voltage or causing any defects to the materials, and the lifespan is even up to thirty thousand times or more. In addition, the present invention is combined with an image display module to act as a mask for the 2D/3D image display, and the image display requires higher resolution and light transmittance. Compared with the conventional electrochromic multi-layer structure, the electrochromic layer of the present invention does not require a combination of an electrolyte or any other auxiliary color changing layer, and thus reducing the thickness and enhancing the light extracting rate significantly.

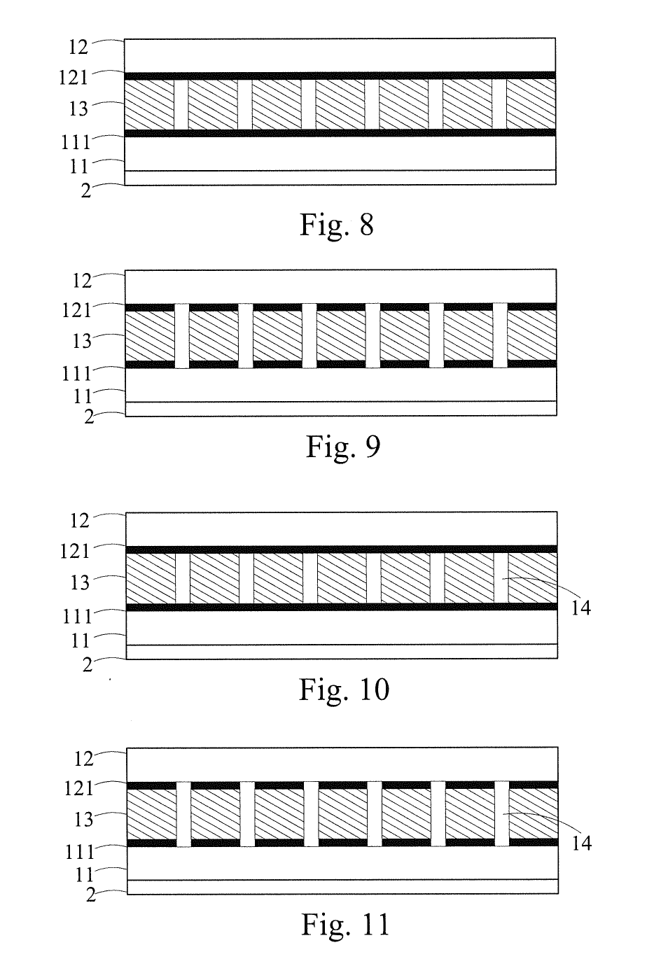

With reference to FIGS. 8 and 9 for first and second schematic views of a transparent conductive element in accordance with a second preferred embodiment of the present invention, whole pieces of the first transparent conductive element 111 and the second transparent conductive element 121 are disposed on surfaces of the first transparent substrate 11 and the second transparent substrate 12 respectively, or are disposed with an interval apart from each other on the first transparent conductive element 111 and the second transparent conductive element 121 respectively according to the position and the quantity of the electrochromic layers 13.

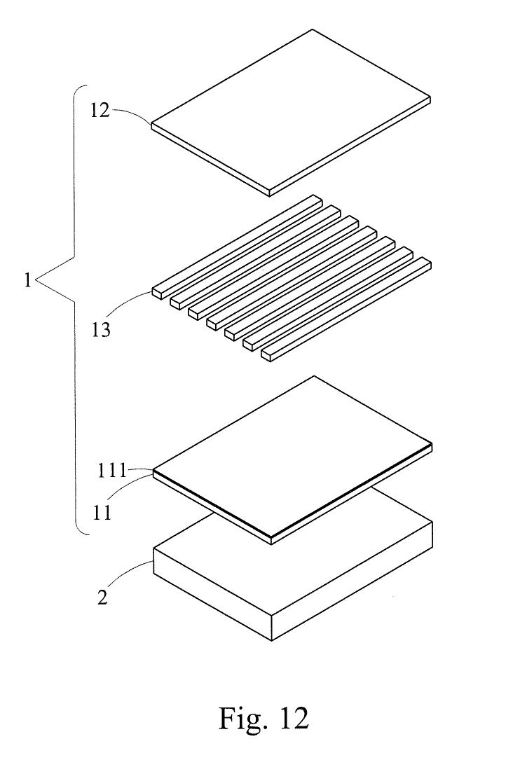

The electrochromic layers 13 can be mixed with highly conductive polymers to form an electrochromic ink used together and coated onto the first transparent substrate 11 by a screen printing method. With reference to FIGS. 10 and 11 for first and second schematic views of a transparent conductive element in accordance with a third preferred embodiment of the present invention, the plurality of isolating units 14 are disposed with an interval apart from each other between the electrochromic layers 13 and provided for separating the electrochromic layers 13 into strips, or the isolating unit 14 is used for packaging the electrochromic layers 13 into the spaces formed by the isolating units 14, wherein the isolating unit 14 is a photoresist.

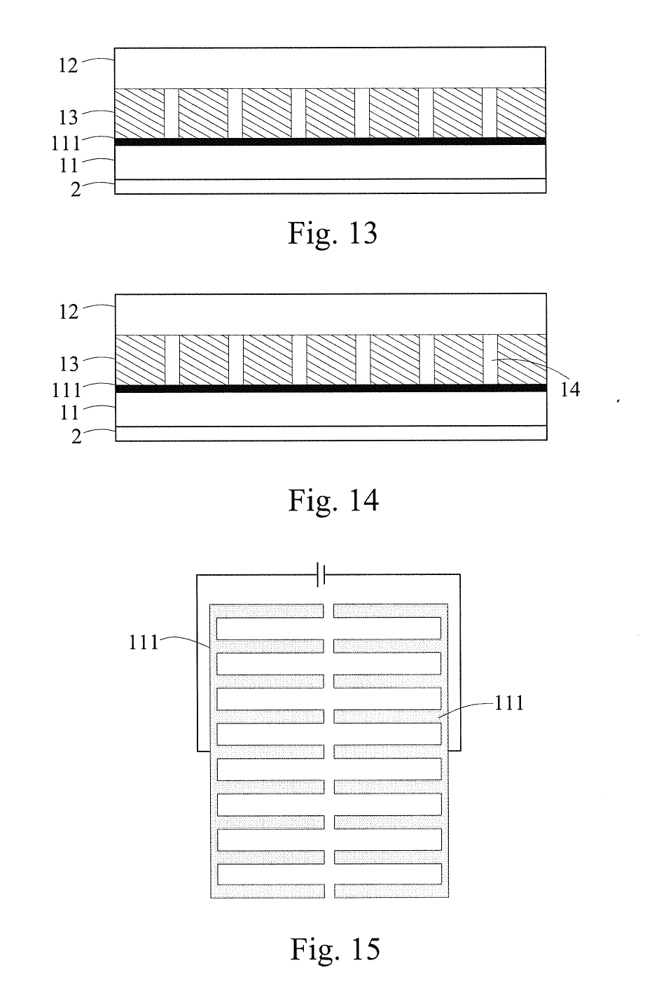

With reference to FIGS. 12 and 13 for a schematic view and a cross-sectional view of a transparent conductive element in accordance with a fourth preferred embodiment of the present invention, the difference of this preferred embodiment from the second preferred embodiment resides on that the first transparent substrate 11 has a plurality of first transparent conductive elements 111 arranged with an interval apart from each other to simplify the manufacturing process of the module. Further, the plurality of isolating units 14 are formed between the electrochromic layers 13 which are separated with an interval apart from each other, and used for enhancing the structural strength and isolating the electrochromic layers 13 as shown in FIG. 14. It is noteworthy to point out that it is necessary to contact each electrochromic layer 13 with two first transparent conductive elements 111 of different potentials at the same time. With reference to FIG. 15 for a schematic view of a transparent conductive element in accordance with the fourth preferred embodiment, each set of oppositely arranged first transparent conductive elements 111 are disposed at positions corresponding to the electrochromic layers 13, such that each electrochromic layer 13 is disposed on the respective first transparent conductive element 111 of different potentials. However, the drawings are provided for the purpose of illustrating the present invention only, but not intended for limiting the present invention, and any changes and modification should be covered by the scope of the present invention.

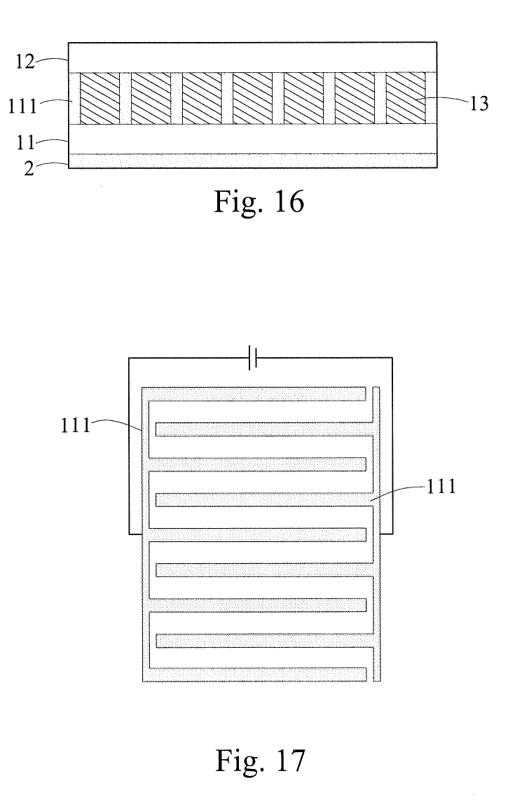

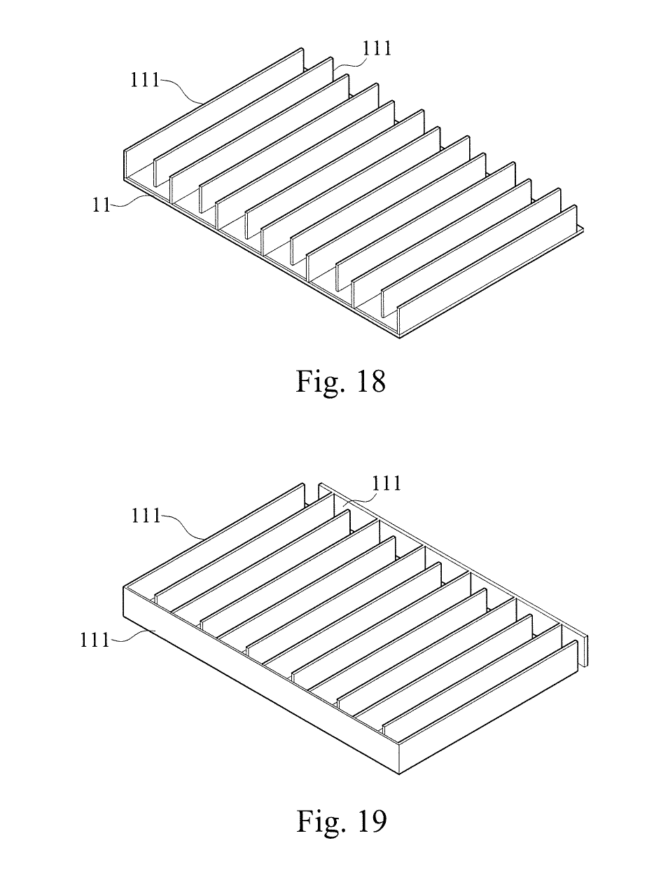

With reference to FIG. 16 for a cross-sectional view of a sixth preferred embodiment of the present invention, the first transparent conductive elements 111 are used as the isolating units directly to achieve the effect of separating the electrochromic layers 13, while increasing the contact area of the electrochromic layer 13 and the first transparent conductive element 111. With reference to FIG. 17 for a top view of the first transparent conductive elements, two groups of first transparent conductive elements 111 arranged with an interval apart from each other and disposed on a first transparent substrate 11 alternately, such that a voltage difference is produced between two adjacent first transparent conductive elements 111 of different potentials. With reference to FIGS. 18 and 19 for first and second perspective views of a transparent conductive element in accordance with the present invention, the first transparent conductive elements 111 can be in form of partitions (as shown in FIG. 18) or in form of a plurality of containing slots (as shown in FIG. 19) for disposing the electrochromic layers 13 into the containing slots respectively. It is noteworthy to point out that the first transparent conductive elements 111 of different potentials will not be in contact with each other, but they are arranged alternately with an interval apart from each other.

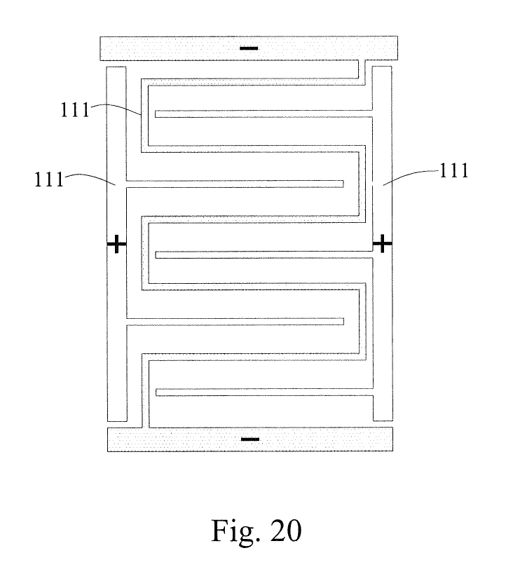

In the structure as shown in FIG. 17, the electrochromic layer 13 will be situated at the anode under a specific condition, and the electrode on the left side of the figure shows a color change effect declines at a position proximate to the anode as time goes by, and forms a color difference with the cathode due to the electric field effect. To overcome this problem, the first transparent conductive element 111 can be designed with the structure as shown in FIG. 20, wherein the figure shows the second upper view of the first transparent conductive elements, and the first transparent conductive element 111 with a negative voltage is covered onto the first transparent conductive element 111 with a positive voltage by an S-shaped way.

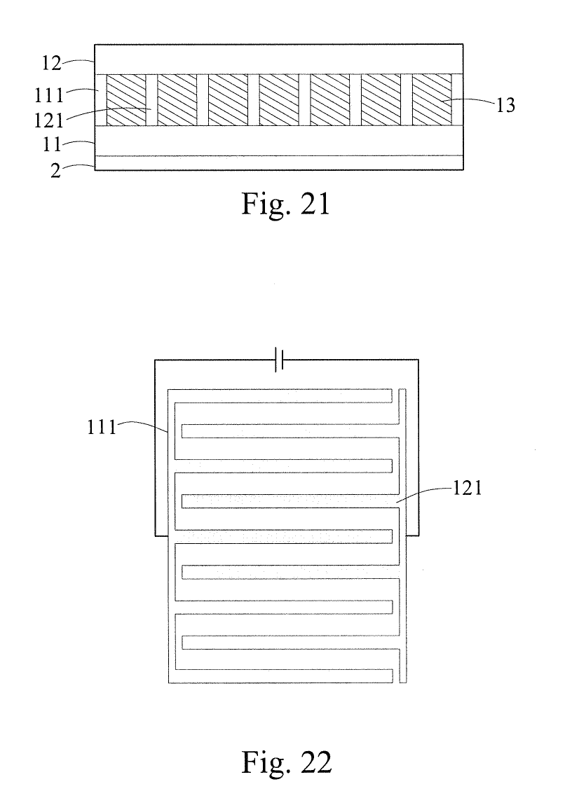

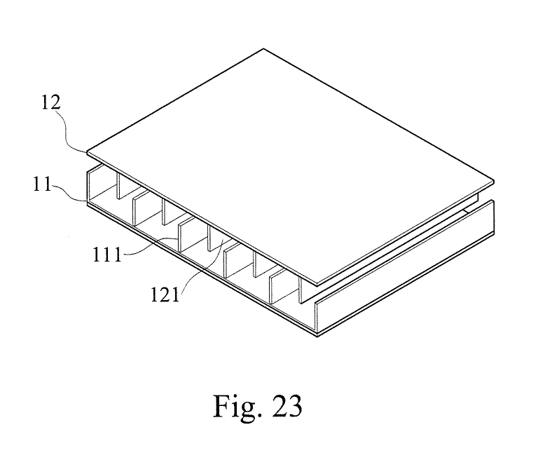

With reference to FIG. 21 for a cross-sectional view of a seventh preferred embodiment of the present invention, the first transparent conductive elements 111 and the second transparent conductive elements 121 are arranged with an interval apart from each other and between surfaces of the first transparent substrate 11 and the second transparent substrate 12, and a plurality of spatial areas is formed between the first transparent substrates 11 and the second transparent substrates 12, and the electrochromic layers 13 are disposed in the spatial areas respectively. The objective of the aforementioned arrangement is to use the first transparent conductive element 111 and the second transparent conductive element 121 as the isolating units. With reference to FIGS. 22 and 23 for an upper view and a perspective view of an electrically conductive element in accordance with a seventh preferred embodiment of the present invention respectively, the first transparent conductive elements 111 and the second transparent conductive elements 121 are arranged alternately with an interval apart from each other, and the first transparent conductive elements 111 supply a positive voltage, and the second transparent conductive elements 121 supply a negative voltage, and vice versa, such that a voltage difference is formed between the first transparent conductive element 111 and the second transparent conductive element 112. However, such arrangement is provided as an example for illustrating the invention only, but not intended for limiting the invention. Any modification and change equivalent to the invention is covered by the scope of the present invention.

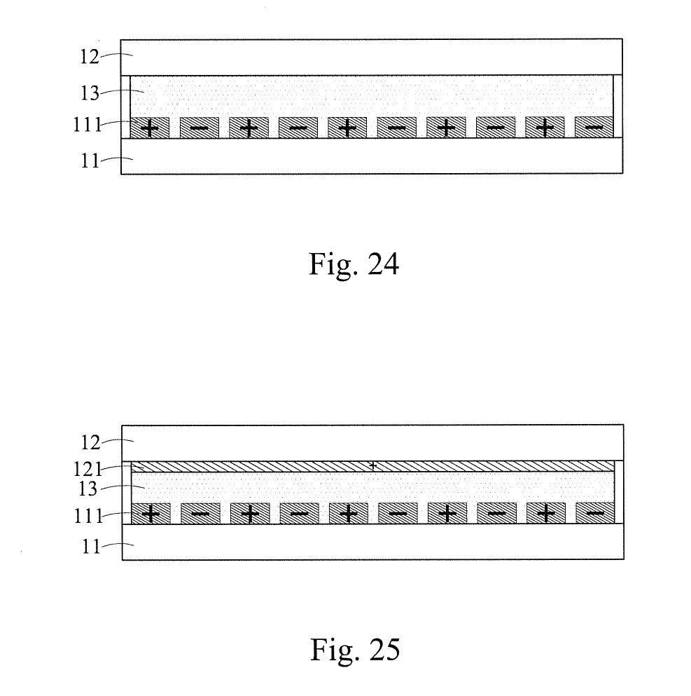

With reference to FIGS. 24 and 25 for cross-sectional views of eighth and ninth preferred embodiments of the present invention respectively, the effect of changing colors of the electrochromic layer 13 varies with the concentration of the solution, the electric potential, the polarity of the solvent, the pH value, the electrode gap and the dielectric constant. In the figure, a plurality of first transparent conductive elements 111 arranged with an interval apart from each other and disposed on a surface of the first transparent substrate 11 supply positive and negative voltages alternately, and the electrochromic layer 13 filled between the first transparent substrate 11 and the second transparent substrate 12 is covered by the first transparent conductive element 111 of the cathode for a color change. In FIG. 24, a second transparent conductive element 121 is set on a lower surface of the second transparent substrate 12 to achieve the effect of precisely changing colors of the solution type electrochromic layer 13 at the surface and periphery of the first transparent conductive elements 111 of the cathode, and the second transparent conductive element 121 just supplies a positive voltage, so that the color change range of the electrochromic layer 13 is limited to the first transparent conductive elements 111 of the cathodes.

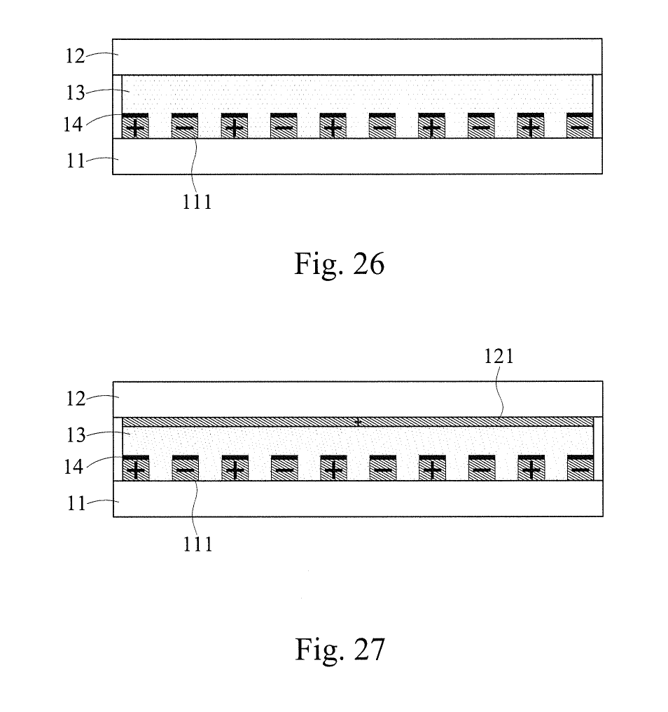

With reference to FIGS. 26 and 27 for cross-sectional views of tenth and eleventh preferred embodiment of the present invention respectively, the first transparent substrate 11 includes a plurality of first transparent conductive elements 111 arranged with an interval apart from each other, and the first transparent conductive elements 111 supply positive and negative voltages alternately, and the first transparent conductive elements 111 include a plurality of isolating units 14 disposed on surfaces of the first transparent conductive elements 11, and the surface of each first transparent conductive element 111 is covered completely, and after the power is supplied, the electrochromic layer 13 changes its color at the gap between the first transparent conductive elements 111 of positive and negative voltages. Since the electrochromic layer 13 is attached onto the wall of the first transparent conductive elements 111 to change its color, therefore the isolating units 14 are provided for blocking the electrochromic layer 13 from attaching onto the surface of the first transparent conductive element 111 to produce a color change. Preferably, the electrochromic layer 13 can be a photoresist. With reference to FIG. 26 for another modification of the tenth preferred embodiment, at least one second transparent conductive element 121 is set on a lower surface of the second transparent substrate 12 to control the color change of the electrochromic layer 13 between the first transparent conductive elements 111 of positive and negative voltages, and the second transparent conductive element 121 just supplies a positive voltage to limit the color change range of the electrochromic layer 13.

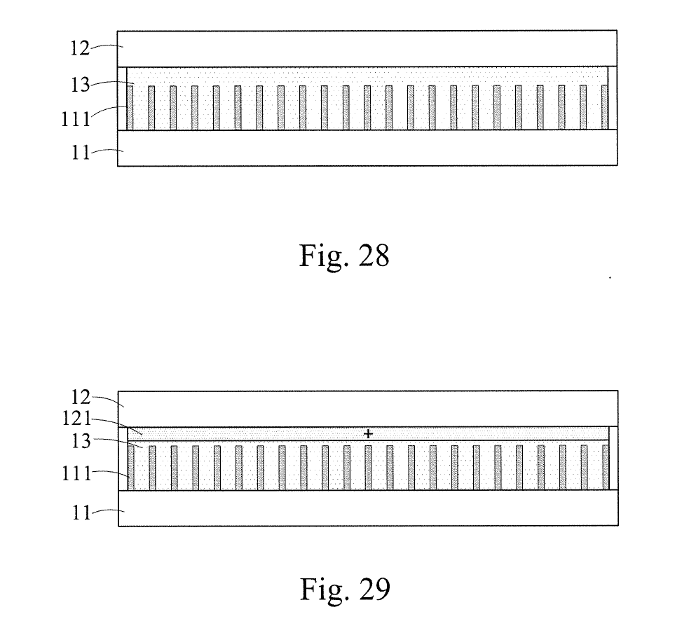

With reference to FIGS. 28 and 29 for cross-sectional views of twelfth and thirteenth preferred embodiments of the present invention respectively, the electrochromic module in accordance with the eighth preferred embodiment as shown in FIG. 23 is disposed onto a larger area of the substrate, and the first transparent conductive elements 111 in accordance with the eleventh preferred embodiment as shown in FIG. 27 are set in form of slender partitions onto the surface of the first transparent substrate 11, but a gap is reserved between the partition and the second transparent substrate 12, such that the electrochromic layer 13 can flow freely in the space packaged by the first transparent substrate 11 and the second transparent substrate 12, and the method of supplying power is to supply positive and negative voltages alternately, and the electrochromic layer 13 is covered onto the periphery of the first transparent conductive element 111 of the cathode for a color change. In FIG. 29, a second transparent conductive element 121 is set on a lower surface of the second transparent substrate 12 to achieve the effect of precisely changing colors of the solution type electrochromic layer 13 at the surface and periphery of the first transparent conductive elements 111 of the cathode, and the second transparent conductive element 121 just supplies a positive voltage, so that the color change range of the electrochromic layer 13 is limited to the first transparent conductive elements 111 of the cathodes.

The display device of the present invention includes the electrochromic module 1 together with the image display module 2. In other words, the electrochromic module 1 is installed on an image projection surface of the image display module 2, and after a processed overlapped image (divided into a left-eye image L and a right-eye image R) is displayed on the image display module 2, the electrochromic layers 13 are arranged with an interval apart from each other to form light shield areas, and thus no overlapped pattern will be formed after the naked eyes receive the images, thus the 3D image will be formed.

While the invention has been described by means of specific embodiments, numerous modifications and variations could be made thereto by those skilled in the art without departing from the scope and spirit of the invention set forth in the claims.

In summation of the description above, the electrochromic module combined with organic and inorganic materials and the display device combined with the module in accordance with the present invention complies with the patent application requirements, and thus is duly filed for patent application.

What is claimed is:

1. An electrochromic module combined with organic and inorganic materials, comprising:
a first transparent substrate, having at least one first transparent conductive element disposed on a surface of the first transparent substrate;
a second transparent substrate; and
an electrochromic layer, disposed between the first transparent substrate and the second transparent substrate, and produced by mixing into an organic material and an inorganic material into a solvent.

2. The electrochromic module combined with organic and inorganic materials as recited in claim 1, wherein the organic material is a redox indicator or an acid-base indicator.

3. The electrochromic module combined with organic and inorganic materials as recited in claim 2, wherein the redox indicator is one selected from the collection of methylene blue (C₁₆H₁₈ClN₃S.3H₂O), dichlorophenolindophenol sodium (C₁₂H₆Cl₂NNaO₂), N-phenyl-o-anthranilic acid (C₁₃H₁₁NO₂), sodium diphenylamine sulfonate (C₁₂H₁₀NNaO₃S), N,N′-diphenylbenzidine (C₂₀ H₂₀N₂) and methyl viologen.

4. The electrochromic module combined with organic and inorganic materials as recited in claim 2, wherein the acid-base indicator is a variamine blue B diazonium salt (C₁₃H₁₂ClN₃O).

5. The electrochromic module combined with organic and inorganic materials as recited in claim 1, wherein the inorganic material is an oxide, sulfide, chloride or hydroxide of a transition element.

6. The electrochromic module combined with organic and inorganic materials as recited in claim 5, wherein the transition element is an element selected from the collection of a copper subgroup (IB), a zinc subgroup (IIB), a scandium subgroup (IIIB), a titanium subgroup (IVB), a vanadium subgroup (VB), a chromium subgroup (VIB), a manganese subgroup (VIIB), an iron series (VIIIB) and a platinum series (Group VIIIB of Fifth and Sixth Periods).

7. The electrochromic module combined with organic and inorganic materials as recited in claim 1, wherein the inorganic material is an inorganic derivative selected from the collection of a halogen group (VITA), an oxygen group (VIA), a nitrogen group (VA), a carbon group (IVA), a boron group (IIIA), an alkali earth metal group (IIA) and an alkali metal group (IA).

8. The electrochromic module combined with organic and inorganic materials as recited in claim 1, wherein the inorganic material is one selected from the collection of ferrous chloride (FeCl₂), ferric trichloride (FeCl₃), titanium trichloride (TiCl₃), titanium tetrachloride (TiCl₄), bismuth chloride (BiCl₃), copper chloride (CuCl₂) and lithium bromide (LiBr).

9. The electrochromic module combined with organic and inorganic materials as recited in claim 1, wherein the solvent is one selected from the collection of dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxyl propionitrile, dimethyl-formamide, N-methylpyrrolidone, sulfon, 3-methyl sulfone and their mixtures.

10. The electrochromic module combined with organic and inorganic materials as recited in claim 1, wherein the electrochromic layer further includes at least one inert conductive salt.

11. The electrochromic module combined with organic and inorganic materials as recited in claim 10, wherein the inert conductive salt is a lithium, sodium, or tetra-alkylamine salt.

12. The electrochromic module combined with organic and inorganic materials as recited in claim 1, wherein the first transparent conductive elements are arranged with an interval apart from each other and disposed on the first transparent substrate, when there is a plurality of first transparent conductive elements.

13. The electrochromic module combined with organic and inorganic materials as recited in claim 1, wherein the second transparent substrate further comprises a second transparent conductive element disposed on a surface of the second transparent substrate.

14. The electrochromic module combined with organic and inorganic materials as recited in claim 13, wherein the first and second transparent conductive elements are arranged with an interval apart from each other and disposed on the first and second transparent substrates respectively, when there is a plurality of first transparent conductive elements and a plurality of second transparent conductive elements.

15. A display device, comprising:
an image display module, for displaying a 2D image and a 3D image;
an electrochromic module, disposed on a surface of the image display module surface, and comprising:
a first transparent substrate, having at least one first transparent conductive element disposed on a surface of the first transparent substrate;
a second transparent substrate; and
a plurality of electrochromic layers, arranged with an interval apart from each other and disposed between the first transparent substrate and the second transparent substrate, and the electrochromic layers being made of a material produced by mixing an organic material and an inorganic material into a solvent.

16. The display device of claim 15, wherein the organic material is a redox indicator or an acid-base indicator.

17. The display device of claim 16, wherein the redox indicator is one selected from the collection of methylene blue (C₁₆H₈ClN₃S.3H₂O), dichlorophenolindophenol sodium (C₁₂H₆Cl₂NNaO₂), N-phenyl-o-anthranilic acid (C₁₃H₁₁NO₂), sodium diphenylamine sulfonate (C₁₂H₁₀NNaO₃S), N,N′-diphenylbenzidine (C₂₀H₂oN₂) and methyl viologen.

18. The display device of claim 16, wherein the acid-base indicator is variamine blue B diazonium salt (C₁₃H₁₂ClN₃O).

19. The display device of claim 15, wherein the inorganic material is an oxide, a sulfide, a chloride or a hydroxide of a transition element.

20. The display device of claim 19, wherein the transition element is an element selected from the collection of a copper subgroup (IB), a zinc subgroup (IIB), a scandium subgroup (IIIB), a titanium subgroup (IVB), a vanadium subgroup (VB), a chromium subgroup (VIB), a manganese subgroup (VIIB), an iron series (VIIIB) and a platinum series (Group VIIIB of Fifth and Sixth Periods).

21. The display device of claim 15, wherein the inorganic material is an inorganic derivative selected from the collection of a halogen group (VIIA), an oxygen group (VIA), a nitrogen group (VA), a carbon group (IVA), a boron group (IIIA), an alkali earth metal group (IIA) and an alkali metal group (IA).

22. The display device of claim 15, wherein the inorganic material is one selected from the collection of ferrous chloride (FeCl₂), ferric trichloride (FeCl₃), titanium trichloride (TiCl₃), titanium tetrachloride (TiCl₄) bismuth chloride (BiCl₃), copper chloride (CuCl₂) and lithium bromide (LiBr).

23. The display device of claim 15, wherein the solvent is one selected from the collection of dimethyl sulfoxide [(CH₃)₂SO], propylene carbonate (C₄H₆O₃), water (H₂O), γ-butyrolactone, acetonitrile, propionitrile, benzonitrile, glutaronitrile, methylglutaronitrile, 3,3′-oxy-2-propionitrile, hydroxyl propionitrile, dimethyl-formamide, N-methylpyrrolidone, sulfolane, 3-methyl sulfolane and their mixtures.

24. The display device of claim 15, wherein the electrochromic layer further includes at least one inert conductive salt.

25. The display device of claim 24, wherein the inert conductive salt is a lithium, sodium, or tetra-alkylamine salt.

26. The display device of claim 15, wherein the electrochromic layers are mixed with a highly conductive polymer to form an electrochromic ink.

27. The display device of claim 15, wherein the first transparent conductive elements are arranged with an interval apart from each other and disposed on the first transparent substrate, when there is a plurality of the first transparent conductive elements.

28. The display device of claim 27, wherein the electrochromic layers are disposed between the first transparent conductive elements and separated by the first transparent conductive elements.

29. The display device of claim 27, wherein the first transparent conductive elements further include a plurality of containing slots formed thereon respectively, and the electrochromic layers are disposed into the containing slots respectively.

30. The display device of claim 27, wherein the first transparent conductive elements supply positive and negative voltages alternately.

31. The display device of claim 27, wherein the first transparent conductive elements surface further includes an isolating unit covered onto a surface of the first transparent conductive elements.

32. The display device of claim 31, wherein the isolating unit is a photoresist.

33. The display device of claim 15, further comprising a plurality of isolating units arranged with an interval apart from each other and disposed between the transparent substrates, and the electrochromic layers are disposed between the isolating units.

34. The display device of claim 33, wherein the isolating unit is a photoresist.

35. The display device of claim 15, further comprising at least one second transparent conductive element disposed on a surface of the second transparent substrate.

36. The display device of claim 35, wherein the first and second transparent conductive elements are arranged with an interval apart from each other and disposed on corresponding surfaces of the first and second transparent substrates, when there is a plurality of first transparent conductive elements and a plurality of second transparent conductive elements, and each electrochromic layer produces a color change according to each set of electrically conducted first and second transparent conductive elements.

37. The display device of claim 35, wherein the first transparent conductive elements and the second transparent conductive elements are arranged sequentially between the transparent substrates, when there is a plurality of first transparent conductive elements and a plurality of second transparent conductive elements, and the electrochromic layers are disposed between the first transparent conductive elements and the second transparent conductive elements.

38. The display device of claim 35, further comprising a plurality of isolating units arranged with an interval apart from each other and disposed between the transparent substrates, and the electrochromic layers are disposed between the isolating units respectively.

39. The display device of claim 38, wherein the isolating unit is a photoresist.

40. The display device of claim 35, wherein the first transparent conductive elements further include a plurality of isolating units formed and covered onto surfaces of the first transparent conductive elements respectively, when there is a plurality of first transparent conductive elements.

41. The display device of claim 40, wherein the isolating unit is a photoresist.

42. The display device of claim 35, wherein when there is a plurality of first transparent conductive elements, the first transparent conductive elements are arranged with an interval apart from each other and disposed on surfaces of the first transparent substrates for supplying positive and negative voltages alternately, and the second transparent conductive element supplies a positive voltage.
